(19) United States
(12) Patent Application Publication
(10) Pub. No.: US 2021/0386135 A1
(43) Pub. Date: Dec. 16, 2021

(54) DISPOSABLE MASK

(71) Applicant: KOKEN LTD., Tokyo (JP)

(72) Inventors: Kohei SHIRAISHI, Tokyo (JP); Hironobu TAKEUCHI, Tokyo (JP)

(21) Appl. No.: 17/283,547

(22) PCT Filed: Oct. 8, 2019
(86) PCT No.: PCT/JP2019/039671

§ 371 Date: Apr. 8, 2021

(30) Foreign Application Priority Data
Oct. 12, 2018 (JP) 2018-193560

(51) Int. Cl. A41D 13/11; A41D 31/18

(52) U.S. Cl. CPC A41D 13/1138; A41D 31/185

(57) ABSTRACT

There is provided a disposable mask that can prevent an impairment of a fit feeling by displacement of the mask even when the face of a wearer moves due to a conversation or a change in an expression of the face. A face-contact body of a disposable mask includes a fixed part joined to a peripheral edge part, an inner peripheral wall part in an annular shape extending inward from the fixed part, a central opening surrounded by the inner peripheral wall part, a first layer disposed on a side of a front face, a second layer disposed on a side of a rear face, and an intermediate layer disposed between the first and second layers in a front-rear direction. The first and second layers and the intermediate layer are joined to one another only through the fixed part.

### RELATED APPLICATIONS

The present application is a National Phase of PCT/JP2019/039671, filed Oct. 8, 2019, and claims priority based on Japanese Patent Application No. 2018/193560, filed Oct. 12, 2018.

### TECHNICAL FIELD

The present invention relates to a disposable mask.

### BACKGROUND

Conventionally, disposable masks used for dust prevention or the like are well known. For example, Patent Literature 1 discloses a disposable mask including a mask body having a covering part in a cup shape for covering a mouth and a nose of a wearer and a face-contact body joined to a peripheral edge part of the covering part, and a pair of fastening cords extending from both lateral edges of the mask body. The face-contact body is made of an elastic material such as a urethane foam.

### CITATION LIST

### Patent Literature

Patent Literature 1: Japanese Unexamined Utility Model Application Publication No. 64-26049

According to the disposable mask disclosed in the Patent Literature 1, the face-contact body is elastically deformable and is in close contact with the face when the mask is worn, and thus a required sealing performance can be exerted, and the mask can be worn comfortably with an excellent fit.

Although the mask disclosed in the Patent Literature 1 can exert the required sealing performance by the face-contact body that is in close contact with the face in a normal wearing state, the face-contact body may be pushed down, and the entire mask may be displaced downward when the wearer opens his/her mouth wide in speaking. The entire mask may be displaced upward when the wearer makes a grimace. When the mask is displaced upward or downward, the fit is deteriorated, which may cause discomfort to the wearer.

### SUMMARY OF THE INVENTION

### Technical Problem

An object of the present invention is to improve conventional inventions and to provide a disposable mask that is free from risk of a displacement to deteriorate a fit even when the face of a wearer moves due to speaking or a change in facial expression.

### Solution to Problem

The present invention is directed to a disposable mask having a front-back direction, and including a mask body having a covering part in a cup shape and a face-contact body joined to a peripheral edge part of the covering part.

In the disposable mask according to the present invention, the face-contact body includes a fixed part joined to the peripheral edge part, an inner peripheral wall part in an annular shape extending inward from the fixed part, a central opening surrounded by the inner peripheral wall part, a first layer disposed on a front face side, a second layer disposed on a rear face side, and an intermediate layer disposed between the first layer and the second layer in the front-back direction. The first layer, second layer and intermediate layer are joined to one another only through the fixed part.

### Advantageous Effects of Invention

In the disposable mask according to the present invention, since the first layer, second layer, and intermediate layer of the face-contact body are joined to one another only through the fixed part, at least the second layer out of the intermediate layer and the second layer deforms so as to follow the facial movement even when the face of the wearer moves due to speaking or a change in facial expression. As a result, the face-contact body can remain in close contact with the face.

### BRIEF DESCRIPTION OF DRAWINGS

FIG. 1 is a perspective view of a disposable mask according to the present invention viewed from a front face side.

FIG. 2 is a rear side view of the mask.

FIG. 3 is a cross-sectional view taken along the line III-III of FIG. 2, in a wearing state of the mask.

FIG. 4 is a cross-sectional view, similar to FIG. 3, in a state where a wearer opens his/her mouth wide.

FIG. 5A is a partially enlarged view of a region surrounded by a dashed line V(a) in FIG. 4. FIG. 5B is a partially enlarged view, similar to FIG. 5A, according to another embodiment.

FIG. 6 is a diagram illustrating a state when a dynamic friction coefficient of each sample is measured.

### DESCRIPTION OF EMBODIMENTS

### First Embodiment

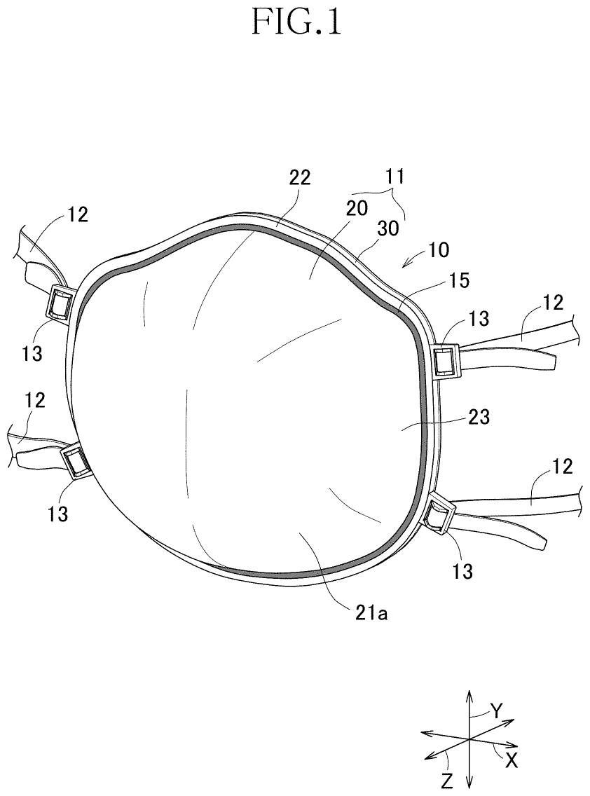

Referring to FIGS. 1 to 4, a disposable mask 10 has a longitudinal direction Y, a transverse direction X, and a front-back direction Z, and includes a mask body 11 having a covering part (a filter part) 20 in a cup shape and a face-contact body 30 joined to a peripheral edge part of the covering part 20, and a pair of fastening cords 12 extending from both lateral edges of the mask body 11. The mask body further has a longitudinal center line P bisecting a dimension in the transverse direction X, and a transverse center line Q bisecting a dimension in the longitudinal direction Y.

The covering part 20 is formed in a cup shape so as to cover the mouth and the nose in the face of a wearer, and includes a front face 21a that is a bottom of a cup, a rear face 21b to be in contact with the face of the wearer, a peripheral edge part 22 that is an edge of the cup, and a peripheral wall part 23 disposed between the front face 21a and the peripheral edge part 22 to define an internal space.

The covering part 20 is formed of a main body sheet made of an air-permeable sheet material such as a fibrous non-woven fabric including a thermoplastic synthetic fiber, a woven fabric, a porous plastic film, or a laminate sheet thereof. The covering part 20 allows intaking inhalation and discharging exhalation of the wearer, and thus functions as a filter part capable of filtering the inhalation and exhalation.

The face-contact body 30 has an annular shape that follows the peripheral edge part 22 of the covering part 20, and includes a fixed part 31 that is fixed on the rear face 21b side of the peripheral edge part 22 on a seal line (a fusing line) 15 circling the peripheral edge part 22, an inner peripheral wall part 32 extending inward from the fixed part 31, and a central opening 33 surrounded by the inner peripheral wall part 32. The fixed part 31 of the face-contact body 30 and the peripheral edge part 22 of the covering part 20 are overlapped with each other at the seal line 15. Such overlapped part is entirely or locally pressured and heated by the seal line 15 in which the thermoplastic synthetic fibers contained in the peripheral edge part 22 are fused to be integrally joined to the face-contact body 30. When the face-contact body 30 contains the thermoplastic synthetic fiber or a thermoplastic synthetic resin, a sealing strength of the seal line 15 can be further enhanced. In this manner, outer peripheral edge parts of the covering part 20 and the face-contact body 30 are sealed by the seal line 15, which can prevent outside air from entering the mask 10 therethrough.

The face-contact body 30 has a three-dimensional shape having irregularities so as to follow the facial unevenness, and especially includes an upper end part 32A to be in contact with a bridge of the nose of the wearer and a lower end part 32B to be in contact with the lower jaw. The pair of fastening cords 12 are connected to the mask body 11 through plastic latch members 13 fixed by the seal line 15 in a state of being interposed between the covering part 20 and the face-contact body 30. In this matter, the face-contact body 30 may have a flat shape to be in planar contact with the face, instead of the three-dimensional shape having the irregularities.

The face-contact body 30 includes an inner layer (a first layer) 40 disposed on the front face 21a side, an outer layer (a second layer) 50 disposed on rear face 21b side, and an intermediate layer 60 disposed between the inner and outer layers (the first and second layers) 40 and 50 in the front-rear direction Z. The inner layer 40 can be formed of a plastic film, a fibrous non-woven fabric, or preferably a foamed elastic body having elastically restorable resilience. When the inner layer 40 is formed of the foamed elastic body, for example, a foamed urethane, a foamed polystyrene, or a foamed polyethylene urethane foam can be suitably used. According to the present embodiment, the inner layer 40 is formed of the foamed elastic body having a required thickness.

The intermediate layer 60 is thinner and more flexible than the inner layer 40, and can be formed of a plastic film, a fibrous non-woven fabric, or a laminate sheet thereof that is preferably air-impermeable and highly airtight. Being air-impermeable as used here is a property of preventing the air from passing through, and means that the air-permeability is considerably low compared with a film or a nonwoven fabric having a general air-permeability, or is almost none. The air-permeability can be evaluated by an amount of passing air in a given time period.

The outer layer 50 can be formed of a plastic film, a fibrous non-woven fabric, or a laminate sheet thereof. The outer layer 50 can also be formed of a sheet having stretchability, such as an elastic non-woven fabric containing an elastic fiber made of a polyurethane elastic fiber or a thermoplastic elastomer, a urethane sheet, or a stretchable (elastic) sheet including an elastic laminate sheet with polyester and polyurethane films.

The inner layer 40 includes an inner peripheral wall part 42 annularly extending inward from the fixed part 31, and an inner opening (a first opening) 43 disposed in a center and surrounded by the inner peripheral wall part 42. The intermediate layer 60 includes an inner peripheral wall part 62 annularly extending inward from the fixed part 31, and an intermediate opening (a second opening) 63 disposed in a center and surrounded by the inner peripheral wall part 62. The outer layer 50 includes an inner peripheral wall part 52 annularly extending inward from the fixed part 31, and an outer opening (a third opening) 53 disposed in a center and surrounded by the inner peripheral wall part 52. The inner peripheral wall part 32 of the face-contact body 30 is formed of the inner peripheral wall part 42 of the inner layer 40, the inner peripheral wall part 62 of the intermediate layer 60, and the inner peripheral wall part 52 of the outer layer 50. The central opening 33 of the face-contact body 30 is formed of the inner opening 43 of the inner layer 40, the intermediate opening 63 of the intermediate layer 60, and the outer opening 53 of the outer layer 50 that communicate with one another, and an opening edge 33a of the central opening is defined by an opening edge 53a of the outer opening 53 of the outer layer 50.

The inner layer 40, intermediate layer 60, and outer layer 50 are disposed so as to overlap with one another in the front-back direction and are joined only through the fixed part 31. The inner peripheral wall parts 42, 52, and 62 extending inward from the fixed part 31 are not joined to one another. Thus, the inner peripheral wall parts 42, 62, and 52 of the respective layers 40, 60, and 50 are separate from one another, and can freely bend or deform without interference with one another. The face-contact body 30 with such a configuration has a basic construction different from that of a conventional face-contact body, for example, which has a two-layer structure including a foamed elastic body layer (an inner layer) and a fibrous non-woven fabric layer (an outer layer) joined to an entire rear face of the foamed elastic body layer with an adhesive.

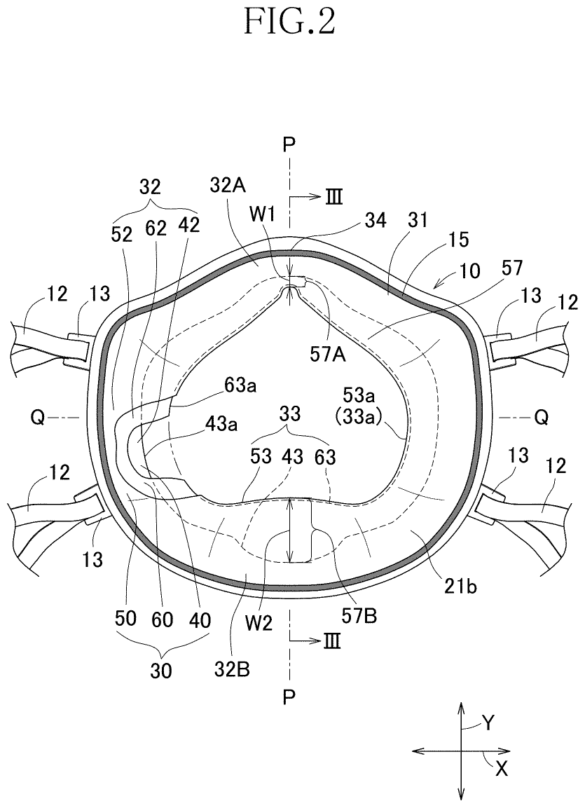

The inner opening 43 of the inner layer 40 has larger area than at least the intermediate opening 63 out of the intermediate opening 63 of the intermediate layer 60 and the outer opening 53 of the outer layer 50. Specifically, referring to FIG. 2, an opening edge 43a of the inner opening is disposed outside an opening edge 63a of the intermediate opening 63 and an opening edge 53a of the outer opening 53 in a radial direction. According to the present embodiment, the opening edge 63a of the intermediate opening 63 is disposed outside the opening edge 53a of the outer opening 53 in the radial direction so as to follow the opening edge 53a, and the intermediate opening 63 is formed slightly larger than the outer opening 53. However, for example, an area of the intermediate opening 63 and an area of the outer opening 53 may be approximately equal and the opening edge 63a and the opening edge 53a may overlap so as to nearly coincide with each other in the front-back direction Z.

The opening edge 43a of the inner opening 43 includes an upper portion protruding upward, and a lower portion protruding downward. The opening edge 63a of the intermediate opening 63 and the opening edge 53a of the outer opening 53 each include an upper portion protruding upward more acutely than that of the opening edge 43a and a lower portion extending in a slightly curving manner in the transverse direction X. With such shapes of the opening edges 43a, 63a, and 53a of the respective layers 40, 60, and 50, the opening edge 43a and the opening edges 63a and 53a are closest to one another at the upper portions and farthest from one another at the lower portions.

The inner peripheral wall part 62 of the intermediate layer 60 and the inner peripheral wall part 52 of the outer layer 50 overlap with each other in the front-back direction Z to define an inner extending part 57 annularly extending inward in the radial direction beyond the inner opening 43 of the inner layer 40. An area of a lower part 57B of the inner extending part 57 is larger than an area of an upper part 57A. A dimension W2 of the lower part 57B on the longitudinal center line P in the longitudinal direction Y is larger than a dimension W1 of the upper part 57A on the longitudinal center line P in the longitudinal direction.

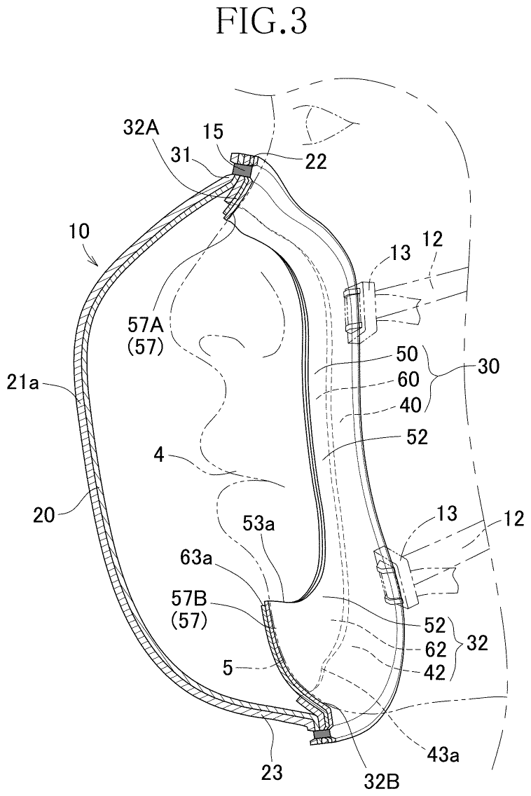

Referring to FIG. 3, in a normal wearing state of the mask 10, the face-contact body 30 is in close contact with the face to exert a high sealing performance, and thus the outside air is blocked from entering the mask 10. Specifically, since the intermediate layer 60 and outer layer 50 joined only through the fixed part 31 are disposed on an inner face side of the inner layer 40 having resilience, in the wearing state, the inner layer 40 elastically deforms so as to follow the uneven facial shape, and the intermediate layer 60 and outer layer 50, which are more flexible than the inner layer 40, come into close contact with the face.

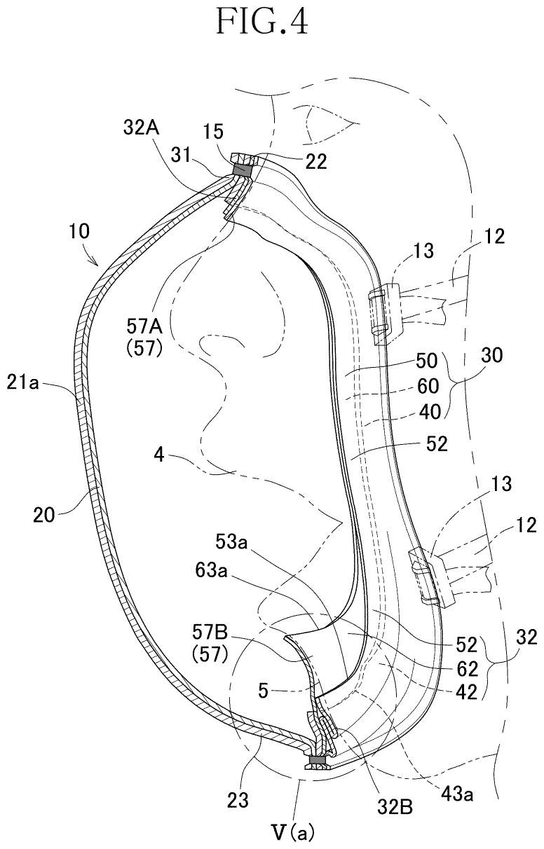

FIG. 4 shows a state of the mask 10 when the wearer opens his/her mouth 4 relatively wide in speaking loudly or giving a big yawn. Even with a conventional mask including a face-contact body made only of a resilient material, the face-contact body fits in a deformed state along the uneven facial shape, and thus a high sealing performance is exerted to effectively suppress entrance of dust or the like into the mask. Therefore, even such a conventional mask can sufficiently ensure the inner airtightness in a normal wearing state. However, when the wearer suddenly speaks loudly, gives a big yawn, makes a grimace, or the like, the face-contact body cannot follow the sudden facial movement, and a slight gap is formed between the face-contact body and the face, which may deteriorate a fit to cause discomfort to the wearer.

In the mask 10 according to the present embodiment, the intermediate layer 60 and outer layer 50 are disposed on the rear face 21b side of the inner layer 40 and are joined only through the fixed part 31, and thus the inner peripheral wall parts 42, 62, and 52 are not joined to one another but in a separated state. As a result, even when the facial shape of the wearer changes, the face-contact body 30 can deform so as to follow the movement.

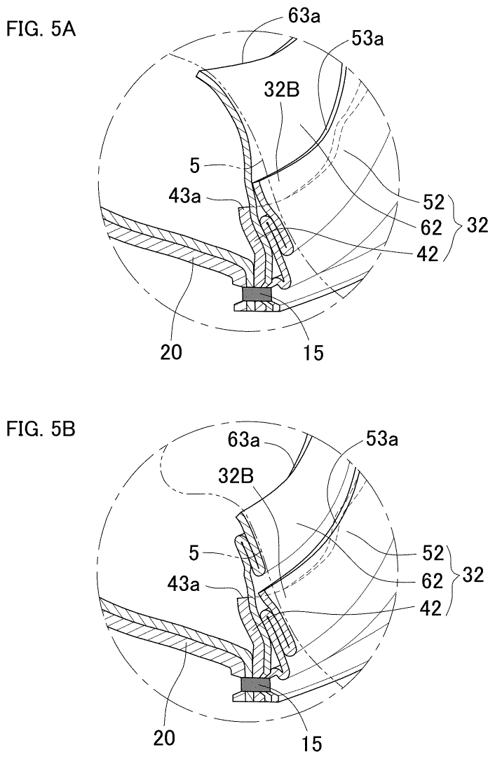

Referring to FIG. 5A showing an example of the embodiment, when the wearer opens his/her mouth 4 wide, the inner peripheral wall part 52 of the outer layer 50 in contact with the face follows the movement of the lower jaw 5 and slides down along the inner peripheral wall part 62 of the intermediate layer 60 to partially bend and deform. As a result, the inner peripheral wall part 52 remains in contact with the lower jaw 5, thereby preventing the outside air from entering the mask 10 through a slight gap formed between the face-contact body 30 and the face. Furthermore, in such an embodiment, the outer layer 50 slides down and thus the inner peripheral wall part of the intermediate layer 60 is exposed. However, since the intermediate layer 60 is substantially air-impermeable, the outside air can be prevented from directly entering the mask 10 through the intermediate layer 60. Furthermore, when the outer layer 50 has stretchability, the outer layer can easily stretch and deform along the facial movement of the wearer to enhance followability.

In such a case, in view of that the outer layer 50 follows the movement of the lower jaw 5 of the wearer and slides down, a frictional resistance R1 between the face and the inner peripheral wall part 52 of the outer layer 50, which is generated when the lower jaw 5 moves downward, is larger than a frictional resistance R2 between the inner peripheral wall part 52 and the inner peripheral wall part 62 of the intermediate layer 60 in contact with the inner peripheral wall part 52.

Referring to FIG. 5B showing an example of another embodiment, similarly to the embodiment in FIG. 5A, when the wearer opens his/her mouth 4 wide, the inner peripheral wall part 52 of the outer layer 50 in contact with the face slides down along the inner peripheral wall part 62 of the intermediate layer 60 so as to follow the movement of the lower jaw 5, and the inner peripheral wall part 62 of the intermediate layer 60 also slides down along the inner peripheral wall part 42 of the inner layer 40. As a result, the inner peripheral wall part 52 remains in contact with the lower jaw 5, thereby preventing the outside air from entering the mask 10 through a slight gap formed between the face-contact body 30 and the face.

In such a case, in view of that the outer layer 50 and the intermediate layer 60 follow the movement of the lower jaw 5 of the wearer and slide down, the frictional resistance R1 between the face and the inner peripheral wall part 52, which is generated when the lower jaw 5 moves downward, is larger than the frictional resistance R2 between the inner peripheral wall part 52 and the inner peripheral wall part 62 of the intermediate layer 60 in contact with the inner peripheral wall part 52, and the frictional resistance R2 is larger than a frictional resistance R3 between the inner peripheral wall part 42 of the inner layer 40 and the inner peripheral wall part 62 of the intermediate layer 50.

As described above, in the embodiments shown in FIGS. 5A and 5B, at least a correlation of the frictional resistance R1>the frictional resistance R2 is established. Accordingly, when the lower jaw 5 moves downward, the inner peripheral wall part 52 of the outer layer 50, which is closest to the skin side and is in contact with the face, bends and deforms so as to follow the movement of the lower jaw 5, thereby maintaining the face and the face-contact body 30 in close contact.

### <Measurement of Frictional Resistance>

The frictional resistances R1 to R3 among the inner peripheral wall parts 42, 52, and 62 of the respective layers 40, 60, and 50 that are in contact with one another can be measured as dynamic friction coefficients, and were measured by a method compliant with JIS K7125 “Plastics-Film and sheeting—Determination of the coefficients of friction” under a standard atmosphere (room temperature at 20° C. and relative humidity at 60%).

First of all, samples 1 to 3 corresponding to the respective layers 40, 60, and 50 and a sample 4 corresponding to the skin of the wearer were prepared.

Sample 1: a sheet made of a foamed polyethylene urethane foam as a material forming the inner layer 40

Sample 2: a laminate sheet made of a plastic film and a fibrous non-woven fabric as a material forming the intermediate layer 60

Sample 3: a fibrous non-woven fabric sheet as a material forming the outer layer 50

Sample 4: an artificial skin (“BIOSKIN” of Beaulax Co., Ltd)

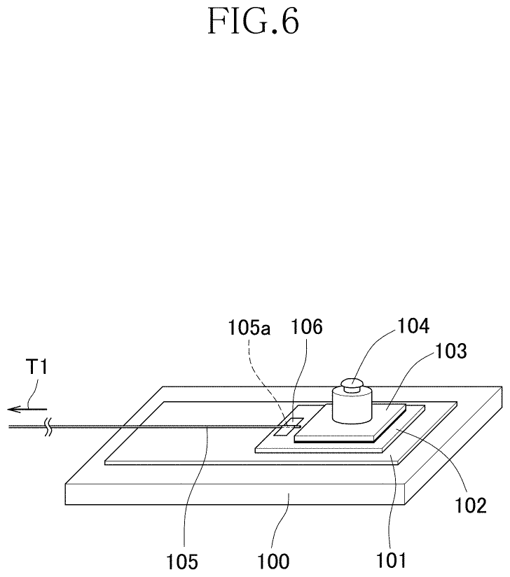

Referring to FIG. 6, for example, when the frictional resistance R1 was measured, the sample 4 was used as an upper test piece 102 and the sample 3 was used as a lower test piece 101. The lower test piece 101 and the upper test piece 102 were placed on a test table 100 having a horizontal and smooth surface, and a sliding piece 103 with felt attached on a bottom thereof was placed on the upper test piece 102, and then a weight 104 (200 g) was quietly placed on the sliding piece 103. An end 105a of a test cable 105 was attached to the upper test piece 102 with a piece of tape 106, and the test cable 105 was pulled in a horizontal direction T1 by a tension testing machine (not shown) at a test speed of 100 mm/min to measure the dynamic friction coefficient (μK) K1. Similarly, when the frictional resistance R2 was measured, the sample 3 was used as the upper test piece 102 and the sample 2 was used as the lower test piece 101, and when the frictional resistance R3 was measured, the sample 2 was used as the upper test piece 102 and the sample 1 was used as the lower test piece 101, to obtain the dynamic friction coefficients K2 and K3.

As a result of the measurement, the dynamic friction coefficient K1 corresponding to the frictional resistance R1 was larger than the dynamic friction coefficient K2 corresponding to the frictional resistance R2, and the dynamic friction coefficient K2 was larger than the dynamic friction coefficient K3 corresponding to the frictional resistance R3.

A correlation among the frictional resistances R1 to R3 can be adjusted by materials used for the respective layers 40, 60, and 50. Specifically, for example, in order to make the frictional resistance R2 smaller than the frictional resistance R1, one of the inner peripheral wall part 52 of the outer layer 50 and the inner peripheral wall part 62 of the intermediate layer 60 is preferably smoother than the inner peripheral wall part 62 or 52 facing the one of the inner peripheral wall parts 52 and 62. For example, when the outer layer 50 is made of a fibrous non-woven fabric and has a rough surface with relatively fine asperities, and the inner peripheral wall part 62 of the intermediate layer 60 is made of a plastic film and has a relatively smooth surface, the inner peripheral wall part 52 of the outer layer 50 smoothly slides along the inner peripheral wall part 62 of the intermediate layer 60, and thus the frictional resistance R2 can be made relatively small. Furthermore, even when both the intermediate layer 60 and the outer layer 50, or both the inner layer 40 and the intermediate layer 60 are made of a fibrous non-woven fabric or a plastic film, the frictional resistance can be made small by giving relatively high smoothness to any one of surfaces mutually in sliding contact.

In addition to adjusting magnitudes of the frictional resistances R1 to R3 by the materials used for the respective layers 40, 60, and 50 as described above, the frictional resistance between surfaces in sliding contact may be made relatively small by applying a frictional resistance reducing agent such as a petroleum jelly, a liquid paraffin, or a wax to any of the surfaces of the inner peripheral wall parts 42, 62, and 52 in sliding contact. Furthermore, the frictional resistance may be made relatively large by applying processing for forming irregularities or attaching a general rubber or a silicone rubber to any of the surfaces.

Various known materials generally used in this kind of field may be used for each component constituting the disposable mask 10 according to the present invention without limitation in addition to the materials described in this description as long as technical effects of the present invention are exerted. The terms “first”, “second”, or the like are used in the description and claims merely to distinguish similar components or positions or the like.

The disclosure related to the present invention described above can be summarized as follows.

The disposable mask has the front-back direction and includes the mask body having the covering part in the cup shape and the face-contact body joined to the peripheral edge part of the covering part. The face-contact body includes the fixed part joined to the peripheral edge part, the inner peripheral wall part in the annular shape extending inward from the fixed part, the central opening surrounded by the inner peripheral wall part, the first layer disposed on the front face side, the second layer disposed on the rear face side, and the intermediate layer disposed between the first layer and the second layer in the front-rear direction. The first layer, second layer and intermediate layer are joined to one another only through the fixed part.

The present invention disclosed in paragraph 0040 can include at least following embodiments. The embodiments can be adopted separately or in combination with one another.

(1) The central opening includes the first opening disposed in the center of the first layer, the second opening disposed in the intermediate layer, and the third opening disposed in the center of the second layer, which overlap and communicate with one another in the front-rear direction. The area of the first opening is larger than at least the area of the third opening out of the second opening and the third opening.

(2) The second layer is made of a stretchable sheet.

(3) The intermediate layer is air-impermeable.

1. A disposable mask having a front-back direction and comprising a mask body including a covering part in a cup shape and a face-contact body joined to a peripheral edge part of the covering part,
wherein the face-contact body includes a fixed part joined to the peripheral edge part, an inner peripheral wall part in an annular shape extending inward from the fixed part, a central opening surrounded by the inner peripheral wall part, a first layer disposed on a front face side, a second layer disposed on a rear face side, and an intermediate layer disposed between the first layer and the second layer in the front-back direction, and
the first layer, second layer, and intermediate layer are joined to one another only through the fixed part.

2. The disposable mask according to claim 1, wherein the central opening comprises a first opening disposed in a center of the first layer, a second opening disposed in the intermediate layer, and a third opening disposed in a center of the second layer, which overlap and communicate with one another in the front-back direction, and an area of the first opening is larger than at least an area of the third opening out of the second opening and the third opening.

3. The disposable mask according to claim 1, wherein the second layer is made of a stretchable sheet.

4. The disposable mask according to claim 1, wherein the intermediate layer is air-impermeable.
